(19) United States
(12) Patent Application Publication
(10) Pub. No.: US 2008/0227460 A1
(43) Pub. Date: Sep. 18, 2008

(54) METHOD AND SYSTEM FOR RECONFIGURING PRIVATE CELLULAR NETWORKS FOR RESOLVING FREQUENCY BAND CONFLICTS WITH OFFICIAL GOVERNMENT COMMUNICATION NETWORKS

(76) Inventors: Greg David, Springfield, NJ (US); Dino C. Giordano, River Vale, NJ (US); Mikhail Sivak, Staten Island, NY (US)

Correspondence Address: DREIER LLP;Susan Formicola, 499 PARK AVE, NEW YORK, NY, 10022, US

(21) Appl. No.: 11/686,438

(22) Filed: Mar. 15, 2007

(51) Int. Cl. H04L 12/26

(52) U.S. Cl. 455/452.1; 370/237

(57) ABSTRACT

Disclosed herein is a system and method for achieving a government-imposed re-banding of communications frequencies within the cellular telecommunications industry that provides considerable advantages over options available in the prior art. Using a bi-directional amplifier means of the present invention, cellular service providers required to shift and otherwise adjust the frequency bands within which they are licensed to operate will be able to conform to government dictates in a manner that is cost effective and capable, without more, of implementing the government-imposed plan in multiple stages without resort to significant hardware upgrades or substitutions.

### FIELD OF THE INVENTION

The present invention relates generally to methods and systems for easily reconfiguring uplink and downlink cellular phone frequency bands in order to avoid frequency conflicts with official government communication networks such as the Public Safety Radio System.

### BACKGROUND OF THE INVENTION

Without doubt, electronics technology has been developing by leaps and bounds over recent years. Perhaps no other area of technological development is more directly reflected in the U.S. economy as these advances find their way into a wide array of increasingly sophisticated consumer products ranging from computers, to home theater systems, and to communications devices (both one-way and two-way) of all varieties. Perhaps nowhere has the consuming public's fascination with electronics resulted in more commercial advances than in cellular telephones. The current surge in popularity of these communications devices has resulted in a seismic shift in how consumers use and view their telephones, with cellular communication making increasing inroads on traditional land line telephone service. A major driving force for this evolution in telephone communication, of course, is the increasing sophistication of the cellular telephone devices themselves. We have come a long way from the first crude, shoebox-sized devices of 15-20 years ago. Today, in a bundle of plastic and electronics frequently smaller than a pack of playing cards, the average consumer is able to use a device that not only functions as a telephone, but is also capable of serving as a virtual desktop computer, while at the same time serving up a rapidly increasing, and diverse, menu of both audio and video entertainment.

Although the U.S. has lagged somewhat behind most of Europe in its move to embrace mobile telephone technology, consumers are fast catching up, in record numbers. Not surprisingly, this has resulted in the proliferation of cellular service providers. Although the industry has seen some inevitable consolidation among providers, the number of providers continues to grow as the demand for service increases. Inevitably, this has resulted in an increasing demand from the industry for broadcast space within the electromagnetic spectrum. As has been the case since virtually the inception of the broadcast industry, as we broadly define that industry, the U.S. government strictly controls and regulates the use of the public airwaves. For the cellular telephone industry, this has resulted in the dedication of a fairly narrow, 140 MHz slice of the broadcast spectrum (from 1850 MHz to 1990 MHz) to two-way communications.

Due to the demand for broadcast frequencies within this relatively crowded spectrum, the possibilities for interference among competing service providers, as well as between cellular providers and other users of two-way radio communications, have been increasing dramatically. It is unlikely that there is a cellular phone user anywhere that has not experienced disruptions in service in the form of dropped signals or the inability to complete a phone connection or even, in some extreme cases, crossing of actual phone connections. Indeed, the public awareness of, and dissatisfaction with, this increasingly common phenomenon is directly reflected in the majority of advertising from cellular service providers, each touting the reliability and range of their product (“Can you hear me now?”). While, for the average cellular communications consumer, this phenomenon rarely rises to more than an irritation, the possibility exists that the crowding of the spectrum dedicated to two-way radio communications can have significant public safety consequences.

The consequences here arise from the use of frequency bands within the available spectrum by public safety agencies such as police and firefighters. The Homeland Security obligations of the nation's public safety agencies make it imperative that their communications systems are robust, highly reliable and free from harmful interference. In major reports following the tragedies of the terrorist attacks on September 11^{th}, the apparent breakdown in communications among emergency responders from the police and fire departments on that day have figured prominently in proposals to improve our country's emergency preparedness. To address the possibility of this interference to the public safety communication systems, the Federal Communications Commission, based on the extensive record developed regarding the public safety interference problem, concluded that the most effective solution is a Commission-derived plan, which is comprised of both long-term and short-term components. Over the long-term, the Commission adopted a new band plan for the 800 MHz band to address the root cause of the interference problem by separating generally incompatible technologies (see FIGS. 2 and 3), with the costs of relocating 800 MHz incumbents to be paid by Nextel Communications, Inc. (Nextel). In the short-term, the Commission implemented objective technical standards—“Enhanced Best Practices”—for defining “unacceptable interference” to public safety systems operating in the 800 MHz band and procedures detailing the responsibilities and expectations regarding abatement of such interference.

Since 1999, the Commission has received reports of interference to 800 MHz public safety communications systems form Commercial Mobile Radio Service (CMRS) providers operating systems on channels in close proximity to those utilized by public safety entities. Initially, the Commission's approach to interference resolution was to urge the involved parties to make voluntary technical changes to prevent or reduce interference at particular sites. In 2000, the public safety and CMRS community formalized this approach as “Best Practices.” In recent years, however, 800 MHz public safety systems have encountered increasing amounts of interference.

As a result, the Commission determined that reliance on these voluntary measures alone was insufficient and thus initiated a rulemaking proceeding to develop the effective solution it has adopted. The Commission has adopted “Enhanced Best Practices” to address interference problems pending completion of the band reconfiguration process. The Commission rejected this as an exclusive remedy for the interference problem because the transactional costs of applying Enhanced Best Practices will continue to increase as new public safety and other non-cellular systems come on line and the commercial carriers using cellular-architecture increase the capacity of their systems by adding more cells. The Commission recognized that these costs will disproportionately affect public safety agencies, which operate with extremely limited resources.

Under the new regime, the Commission adopted an objective technical standard for defining unacceptable interference and placed strict responsibility on carriers to fix such interference. To accomplish the reconfiguration, the Commission will require Nextel to give up rights to certain of its licenses in the 800 MHz band and all of its licenses in the 700 MHz band. In exchange, the Commission will modify Nextel's licenses to provide the right to operate on two five-MHz blocks in a different part of the spectrum—specifically 1910-1915 MHz and 1990-1995 MHz—conditioned on Nextel fulfilling certain obligations specified in the Commission's decision.

The Commission has determined that the overall value of the 1.9 GHz spectrum rights is $4.8 billion, less the cost of relocating incumbent users. In addition, the Commission concluded that it would credit to Nextel the value of the spectrum rights that Nextel will relinquish and the actual costs Nextel incurs for to relocate all incumbents in the 800 MHz band. To the extent that these combined credits total less than the determined value of the 1.9 GHz spectrum rights, Nextel will make an anti-windfall payment to the United States Department of the Treasury at the conclusion of the relocation process equal to the difference.

The Commission's plan will result in an additional 4.5 MHz of 800 MHz-band spectrum, the equivalent of 90 additional two-way channels, becoming available to public safety, critical infrastructure, and private wireless users, including 10 channels for public safety/critical infrastructure interoperability. As with prior spectrum relocation programs initiated by the Commission, Nextel—as the new entrant into public safety bands—will be required to provide the existing public safety licensees with comparable facilities. To ensure that the band reconfiguration process will be completed, the Commission will require Nextel to establish certain escrow accounts and a letter of credit in the amount of $2.5 billion specifically to ensure adequate funding of relocation costs for other 800 MHz incumbents. Similarly, as a new entrant in the 1.9 GHz band, Nextel is also obligated to fund the transition of incumbent users to comparable facilities.

Recognizing the complexity of the band reconfiguration and looking at the experience of other federal agencies that have used a similar process, the Commission provided for an independent “Transition Administrator” to oversee the administrative and financial aspects of the band reconfiguration, provide accountability to the reconfiguration process, and ensure that band reconfiguration is achieved with minimal disruption to licensees, particularly public safety entities. Specifically, the Transition Administrator, whose decisions will be subject to de novo Commission review, will authorize disbursement of funds for band reconfiguration based on requests for payment by affected parties and resolve funding disputes. In the event of a material change in Nextel's financial situation, the Commission concluded that the Transition Administrator would be empowered to take control of the guaranteed funds and complete the band reconfiguration.

The Commission determined that this approach provides significant public interest benefits by quickly resolving the interference problem which reduces operating costs to public safety and commercial providers, creating more spectrum and increased flexibility for public safety licensees, and accelerating band-clearing at 1.9 GHz, all of which demonstrate improved spectrum management over this issue and result in more effective protection of life and safety for both emergency responders and the public.

FIGS. 2 and 3 provide a schematic representations of the features of this plan in comparison to the current FCC assignment of frequency bands. The Plan is designed to protect the lives of first responders and other emergency personnel and fulfills the Commission's obligation to promote safety of life and property through the use of wire and radio communications.

The essence of this plan is to shift and, in some cases change the width of, the frequency bands assigned to cellular service providers and public safety agencies so that greater separation of these bands results, thus minimizing the chance for dangerous interferences. Table 1, below, illustrates the proposed sequencing and timing of the prioritization waves and the corresponding reconfiguration windows.

The Plan is structured to meet the Commission's 18-, 30-, and 36-month deadlines, while at the same time preserving flexibility in the process. More specifically, the Plan's staggered roll-out of reconfiguration “waves” ensures that incumbents authorized to utilize Channels 1-120 (43 NPSPAC regions), in three reconfiguration waves, initiate reconfiguration negotiations by Jan. 3, 2006. Initiating the process so early in the 36-month timeframe for so many NPSPAC regions, and providing each NPSPAC region the flexibility to begin the NPSPAC reconfiguration process as soon as possible, facilitates expeditious system reconfiguration and provides Nextel the opportunity to meet (and, indeed, significantly surpass) the Commission's 18-month interim benchmark requirement by Dec. 27, 2006.

Further, under the Plan, all 800 MHz systems will have commenced reconfiguration in advance of the Commission's 30-month deadline. More specifically, the Plan provides that all NPSPAC regions not dependent on new international treaties will begin actual NPSPAC according to the timetable set out in Table 1.

The implementation of the Plan is not without significant marketplace impact within the industry. Where the result of changes in frequency bands assigned to public safety agencies brings those new band assignments more directly in conflict with existing bands assigned to commercial cellular service providers, the mandates of Home Security, as implemented y the Commission's Plan, prevail and the commercial providers must affect a shift in their assigned frequency bands. This is reflected in the second phase of the reconfiguration where, for example, the frequency band of operation assigned to Nextel must shift as follows: Uplink (816-824 MHz) and Downlink (861-869 MHz). See FIG. 3. In this phase of the Plan, Public Safety will also extend their frequency range to: Uplink (806-816 MHz) and Downlink (851-861 MHz).

TABLE 1

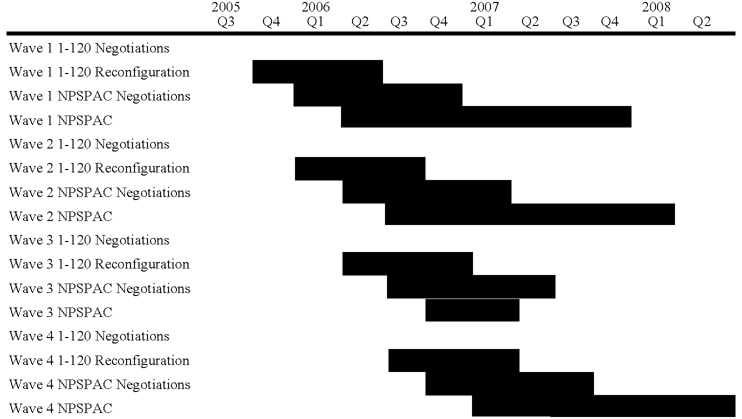

This change in assigned frequency bands both provides a broader frequency band to public safety agencies, potentially increasing the reliability of these essential communications, and reducing the likelihood of interference with those communications from commercial cellular services.

In this situation, an affected cellular provider, such as Nextel, must assume financial responsibility for all reconfigured or upgraded systems (both theirs and Public Safety's). Although the discussion herein will deal with the specifics of the re-banding obligation that the present Plan will impose on Nextel, this is for illustrative purposes only and should not constitute a limitation on the scope of the present invention. Given the possible future development of both technology and demand for wireless communications, it is possible that public safety considerations could result in further reconfiguration of the frequency bands of operation for additional commercial providers and others with assigned frequencies of operation within this, or other, spectra. As the discussion below will clearly illustrate, the novel system and method of the present invention provides an approach to re-banding that is capable of application within a wide range of frequencies and across a varying degree of frequency shifts.

Direct and indirect costs associated with the two phases of re-banding and reconfiguration mandated by the Plan is incorporated in the requirement imposed on Nextel to obtain a $2,500,000,000 letter of credit. Currently, Nextel's equipment operates in the following frequency bands: Uplink (806-821 MHz) and Downlink (851-866 MHz). In addition, they have channels in the SMR900 frequency band: Uplink (896-902 MHz) and Downlink (935-941 MHz). The standard solution available in the prior art is to provide an extended dual band Bi-Directional Amplifier (BDA). This typically operates in the following frequency bands: Uplink (806-824; 896-902 MHz) and Downlink (851-869; 935-941 MHz); an alternative solution is to combine two BDA's, one for the SMR800 band and one for the SMR900. However, when the second re-banding phase is in effect, the initially provides BDA's will have to undergo an upgrade, reconfiguration with additional equipment, or replacement with a new BDA specific to the frequency band shifts of the second phase of the Plan. This upgrade will necessitate a substantial additional cost. Thus, a need exists for a system and method capable of conforming with the two-stage implementation of the Plan that does not require either two distinct hardware configurations or substantial modification to phase I hardware to meet the specifications of phase II. Until the development of the present invention, it has not been possible to effectively and practically meet this need.

### SUMMARY OF THE INVENTION

Disclosed herein is a system for reconfiguring a bidirectional amplifier (“BDA”) to resolve frequency conflicts, the system comprising a downlink path of the BDA to receive at least one first signal from a base station for transmission to a subscriber; an uplink path of the BDA to receive at least one second signal from the subscriber for transmission to a base station; and a re-banding switch in the uplink path and the downlink path operative to change a frequency of operation of the uplink path or the downlink path. Preferably, the re-banding switch is operative to resolve a frequency conflict with a government communication network. Also preferred is a system where the uplink path occupies a first frequency band and the downlink path occupies a second frequency band. More specifically preferred is a system wherein the uplink path and the downlink path occupy SMR distinct frequency bands, such as the SMR800 bands. Most preferred is a system where the uplink path is from 806-824 MHz and the downlink path is from 851-869 MHz.

In an alternative embodiment, there is disclosed a system wherein the uplink path and the downlink path occupy SMR distinct frequency bands, such as the SMR900 bands. Most preferred is a system where the uplink path is from 896-901 MHz and the downlink path is from 935-941 MHz.

Also disclosed is a system where the re-banding switch is operative to change the frequency of operation of the uplink path and the downlink path, and where the re-banding switch is operative to change the frequency of operation in response to the selection of an externally accessible switch, preferably a dual-position switch. In an alternative embodiment, the re-banding switch is operative to change the frequency of operation in response to the receipt of a programmed instruction, preferably wherein a digital interface receives the programmed instruction and interfaces with the re-banding switch to change the frequency of operation.

In yet another embodiment, there is disclosed a system comprising a switched internal duplexer operative to change the frequency of operation to a pre-set re-banding frequency wherein, preferably, the system comprises a quadruplexer operative to isolate the uplink path and the downlink path, wherein the quadruplexer is characterized as four filters, with one common port, that have low bandpass insertion loss and high selectivity.

In an alternative embodiment, the present invention contemplates a system wherein the uplink path and the downlink path occupy PCS distinct frequency bands. Preferred is a system 17 wherein a first duplexer isolates the uplink path in a PCS chain and a second duplexer isolates the downlink path the PCS chain. Also preferred is a system where an internal duplexer isolates non-contiguous PCS frequency blocks.

### BRIEF DESCRIPTION OF THE DRAWINGS

FIG. 1 is a schematic representation of the A, A′, A″, B, and B′ bands within the spectrum assigned by the Federal Communications Commission for cellular communications and its proximity to the public safety bands.

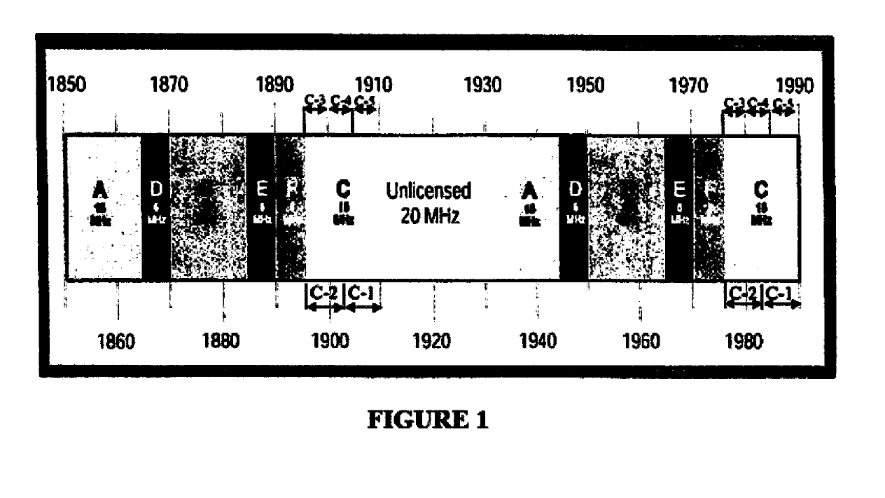

FIG. 2 is a graphic representation of the breakdown of frequency bands prior to a plan proposed by the Federal Communications Commission for re-banding of communications frequencies for cellular and Public Safety communications.

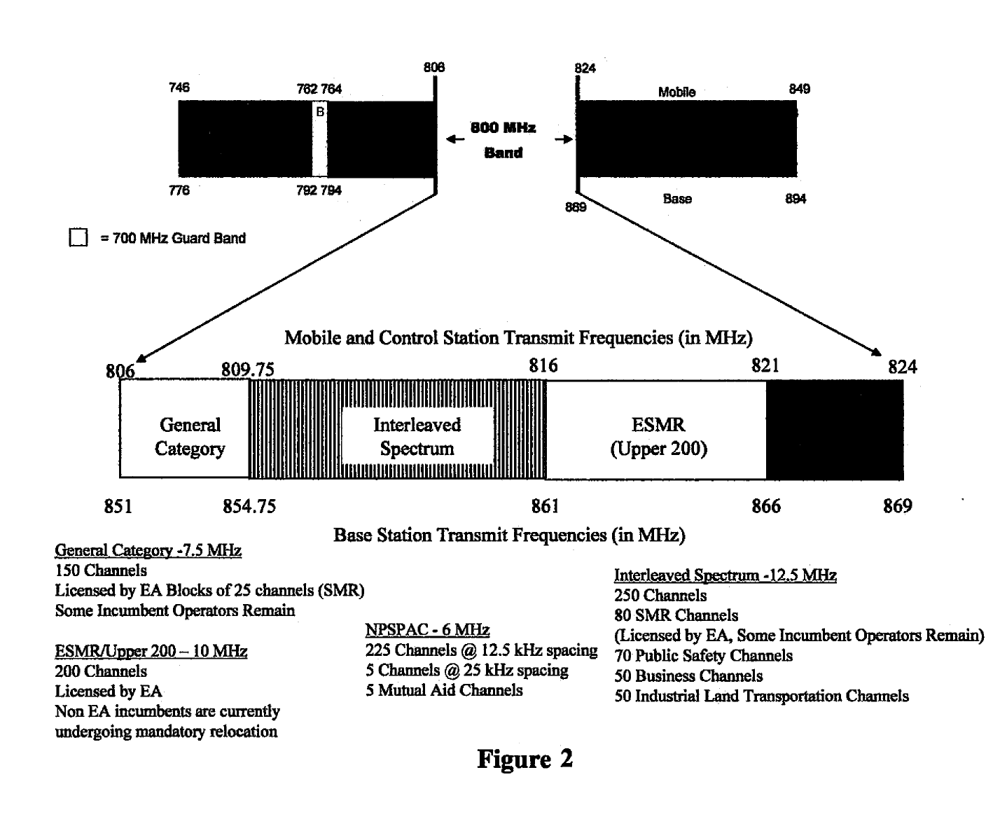

FIG. 3 is a schematic representation of the frequency bands within this region of the spectrum illustrating the changes in frequencies assigned by the Federal Communications Commission for cellular communications, including proximity to the public safety bands.

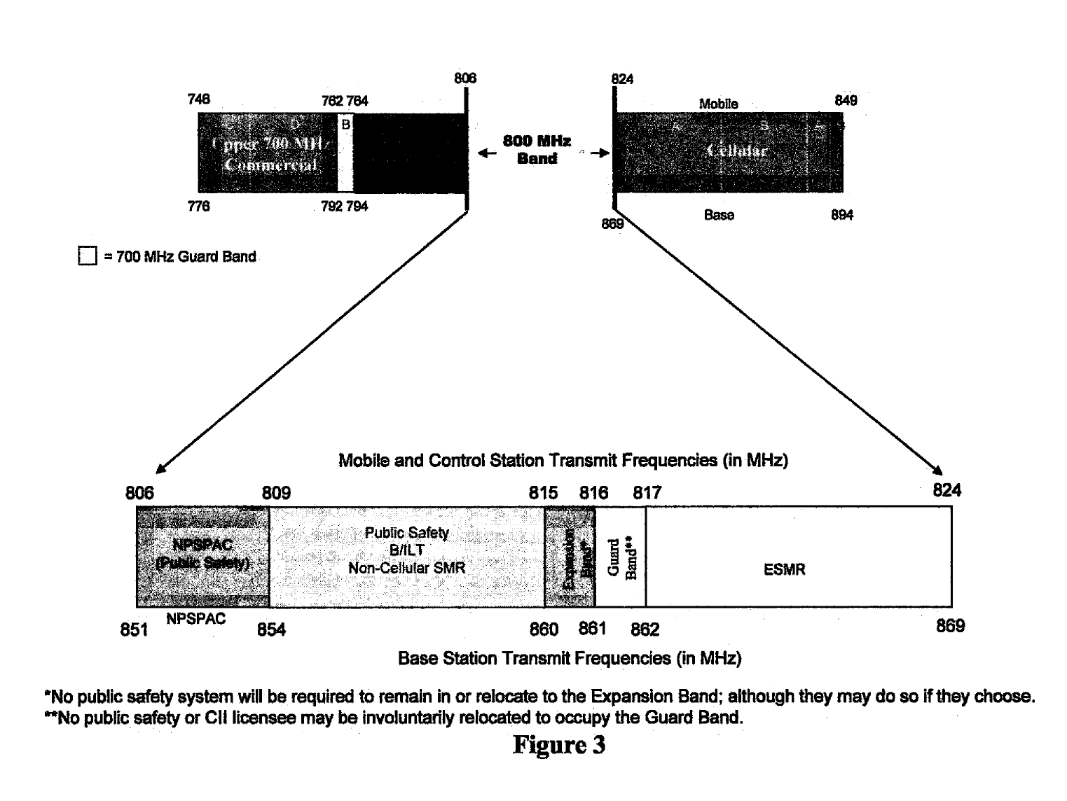

FIG. 4 is a schematic representation of a bi-directional amplifier means of the present invention.

FIG. 5 is a schematic representation of an alternative embodiment of the bi-directional amplifier means of the present invention configured to achieve re-banding of Public Safety frequencies.

### DETAILED DESCRIPTION OF THE INVENTION

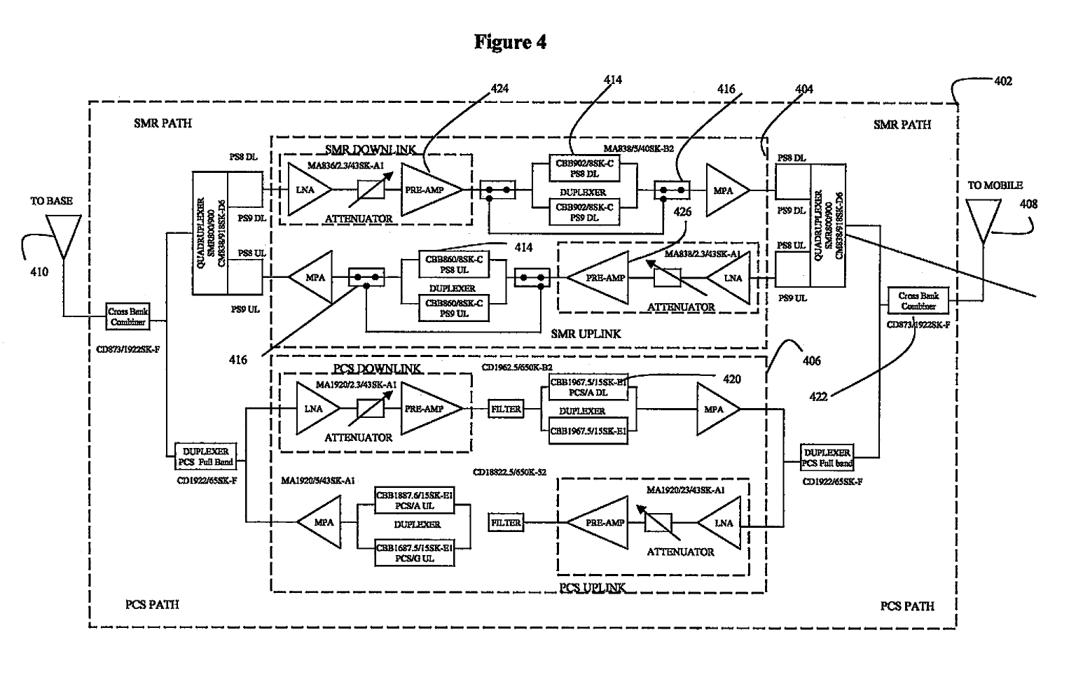

Referring now to FIG. 4, there is provided a schematic representation of the apparatus of the present invention. This apparatus comprises a bi-directional amplifier (BDA) 402 in a novel hardware configuration to achieve the desired ends of the invention. Although BDA's are known in the art, their use in conjunction with commercial cellular systems is typically limited to enhancing signal strength between users and base stations in buildings and radio-frequency (RF) shielded environments where users frequently experience significant degradation of cellular signals. In such use, a BDA of the prior art effectively functions as a hardware sub-system communicating directly with cellular users in one direction and cellular providers in the other to achieve a local boosting of communications between users and their commercial networks. However, such use does not involve any shifting of or change to the frequency bands assigned to the commercial cellular network providers. As such, it is merely a passive amplifier of the signals passing between users and network in environments where such communication is difficult to maintain.

The BDA assembly of the present invention features low noise and wide dynamic range. It is a multi-block system, based on a dual-duplexed (quadruplexer) path configuration with sharp out of band attenuation allowing improved isolation between the receiving and transmitting paths, plus SMR and PCS paths. Integral to the practice of the present invention, and novel to BDA designs, the BDA of the invention comprises integrated re-banding switch means to change the frequency of operation in the ESMR800 band to conform to the specifications of both phase I and phase II of the Commission's Plan.

As illustrated in FIG. 4, the downlink (DL) path of the bi-directional amplifier (BDA) means of the present invention receives radio frequency (RF) signals from the base station and amplifies and transmits them to the subscriber. The BDA uplink (UL) path receives RF signals from the subscriber and amplifies and transmits them to the base station. The UL and DL paths occupy two distinct frequency bands. For SMR distinct frequency bands, specific ESMR800 frequency bands are as follows: (806-824 MHz) for the uplink, and (851-869 MHz) for the downlink; for SMR900 distinct frequency bands, specific bands are as follows: (896-901 MHz) for the uplink, and (935-941 MHz) for the downlink.

Within the BDA means of the present invention, a quadruplexer 412, characterized by low bandpass insertion loss and high selectivity, isolates the uplink and downlink paths in the SMR chain 404, plus a switched internal duplexer 414 changes the ESMR800 frequency band to a pre-set re-banding frequency range. As one of skill in the art will recognize, the switched internal duplexer may be configured in any single application to achieve a pre-determined target shift of frequency band. Thus, by implementing changes in the design of the duplexer, it will be possible, within the practice of the present invention, to implement any shift or change in frequency bands imposed by the Commission in as yet unconsidered plans consistent with the public safety.

Preferably, the BDA means of the present invention additionally comprises a re-banding switch 416. The re-banding switch changes the frequency of operation in the ESMR800 band to uplink (817-824 MHz), and downlink (862-869 MHz). There is no tuning required; operation simply requires, in a preferred embodiment, the selection of the SMR position on an externally-accessible dual-position switch for re-banding frequencies. In an alternative embodiment, such switching may be accomplished through a digital interface in response to programmed instructions sent from a microprocessor means.

For PCS distinct frequency bands A and G, specific PCS A frequency bands are as follows: (1850-1865 MHz) for the uplink, and (1930-1945 MHz) for the downlink PCS G frequency bands are as follows: 1910-1915 MHz for the uplink, and 1990-1995 MHz for the Downlink. In a preferred configuration two duplexers 420 isolate the uplink and downlink paths in the PCS chain, plus an internal duplexer also isolates the non-continuous PCS A and G frequency blocks. A Cross-Band Coupler isolates the SMR and PCS bands. See FIG. 4.

Referring still to FIG. 4, the BDA means of the present invention comprise SMR UL 426 and DL 424 pre-amps drive the UL and DL medium power amplifiers (MPA's) and offer 0-30 dB of manual attenuation in 2-dB steps; the SMR UL and DL MPA's have an ALC feedback loop that limits the output power of the amplifier to its linear range; the BDA means further comprises Cross Band Couplers 422 to isolate SMR and PCS bands.

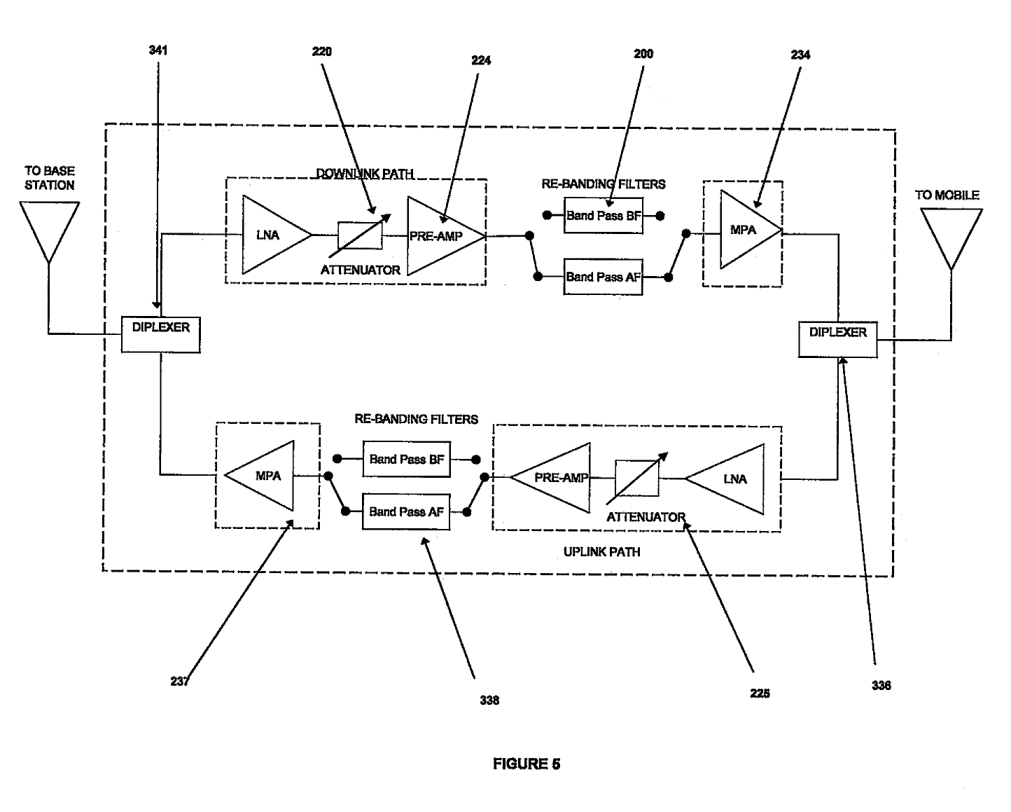

Referring now to FIG. 5, there is a depicted a schematic of an alternative embodiment of the present invention comprising a BDA means configured to achieve a re-banding of Public Safety frequencies. It is expected that the re-banding of the frequencies assigned to commercial cellular telephone providers will be merely a first step in achieving the overall aims of the Plan implemented by the Commission. A logical subsequent step is to accomplish a re-banding of the Public Safety frequencies to further assure that the possibility of interference among the various bands will reduced as much as possible. This re-banding may be achieved in a single step; alternatively, the re-banding of the Public Safety frequencies may be accomplished in a multi-step process. The utility of the present invention is particularly apparent in such a multi-step implementation in the unique hardware configuration embodying the present invention enables a single piece of hardware to achieve the single or multiple-step re-banding without the need to utilize separate hardware configurations for each re-banding or each step of a multi-step re-banding implementation.

Referring specifically to FIG. 5, the BDA downlink path 220 receives RF signals from the base station and amplifies and transmits them to the subscriber. The downlink pre-amp 224 is a low-noise amplifier that drives the downlink medium power amplifier (MPA) 234. A similar MPA 237 performs the same function in the uplink path. The uplink re-banding switch 338 controls the operation frequency band selection between two or more distinct bands. Although FIG. 5 specifically depicts two-position re-banding switches 200 and 338, one of skill in the art will appreciate that it is possible to construct multiple position switches capable of selection to one from among more than two possible positions, thus accomplishing, in conjunction with the operation of the present invention, a single hardware configuration that can implement a multi-step re-banding without the need for separate hardware configurations for each re-banding step.

The BDA uplink path 225 receives RF signals from the subscriber and amplifies and transmits them to the base station. The Uplink and Downlink signals occupy two distinct frequency bands, each controlled by a re-banding switch, 200 and 338, respectively. The low frequency bands are as follows: 806-809 MHz for the Uplink; 851-854 for the Downlink. The high frequency bands are as follows: 821-824 MHz for the Uplink; 866-869 for the Downlink. Two diplexers 336 and 341 isolate the paths and route each signal to the proper amplifying channel. The diplexers have low bandpass insertion loss and high selectivity for their respective frequency bands.

One of ordinary skill in the relevant electronic communication arts will recognize that, while individual hardware components of the BDA means of the present invention are known in the art, the specific combination embodied in the present invention is unique and provides a useful and practical solution to the re-banding requirement imposed on segments of the cellular telephone communication industry, such as Nextel, by the Commission's Plan. Likewise, such skilled practitioners in the art will recognize that individual variations to the means disclosed herein may be achieved without deviating from the inventive concept embodied in the invention disclosed herein and that, in light of this, the Figures and embodiments disclosed are illustrative of the concepts of the practice of the invention and are in no way limiting to the scope of that invention.

What is claimed is:

1. A system for reconfiguring a bidirectional amplifier (“BDA”) to resolve frequency conflicts, the system comprising.
a downlink path of the BDA to receive at least one first signal from a base station for transmission to a subscriber;
an uplink path of the BDA to receive at least one second signal from the subscriber for transmission to a base station; and
a re-banding switch in the uplink path and the downlink path operative to change a frequency of operation of the uplink path or the downlink path.

2. The system of claim 1 wherein the re-banding switch is operative to resolve a frequency conflict with a government communication network

3. The system of claim 1 wherein the uplink path occupies a first frequency band and the downlink path occupies a second frequency band.

4. The system of claim 3 wherein the uplink path and the downlink path occupy SMR distinct frequency bands.

5. The system of claim 4 wherein the SMR distinct frequency bands are SMR800 frequency bands.

6. The system of claim 5 wherein the uplink path is from 806-824 MHz and the downlink path is from 851-869 MHz.

7. The system of claim 4 wherein the SMR distinct frequency bands are SMR900 frequency bands.

8. The system of claim 7 wherein the uplink path is from 896-901 MHz and the downlink path is from 935-941 MHz.

9. The system of claim 4 wherein the re-banding switch is operative to change the frequency of operation of the uplink path and the downlink path.

10. The system of claim 9 wherein the re-banding switch is operative to change the frequency of operation in response to the selection of an externally accessible switch.

11. The system of claim 10 wherein the switch is a dual position switch.

12. The system of claim 9 wherein the re-banding switch is operative to change the frequency of operation in response to the receipt of a programmed instruction.

13. The system of claim 12 wherein a digital interface receives the programmed instruction and interfaces with the re-banding switch to change the frequency of operation.

14. The system of claim 1 comprising a switched internal duplexer operative to change the frequency of operation to a pre-set re-banding frequency.

15. The system of claim 1 comprising a quadruplexer operative to isolate the uplink path and the downlink path.

16. The system of claim 15 wherein the quadruplexer is characterized as four filters with one common port that have low bandpass insertion loss and high selectivity.

17. The system of claim 3 wherein the uplink path and the downlink path occupy PCS distinct frequency bands.

18. The system of claim 17 wherein a first duplexer isolates the downlink path in a PCS chain and a second duplexer isolates the uplink path in the PCS chain.

19. The system of claim 18 wherein an internal duplexer isolates non-contiguous PCS frequency blocks.

20. The system of claim 1 wherein the BDA forms part of a cellular phone network.
